(19) United States
(12) Patent Application Publication
(10) Pub. No.: US 2026/0025199 A1
(43) Pub. Date: Jan. 22, 2026

(54) COMPUTER PERIPHERAL WITH EMBEDDED TRANSCEIVER FOR PROXIMITY DETECTION OF WEARABLE METASURFACES

(71) Applicant: Dell Products L.P., Round Rock, TX (US)

(72) Inventors: Tejinder Singh, Manotick (CA); Navjot Kaur Khaira, Manotick (CA)

(21) Appl. No.: 18/776,001

(22) Filed: Jul. 17, 2024

(51) Int. Cl. H04B 7/26; H04B 1/3827

(52) U.S. Cl. CPC H04B 7/26; H04B 1/385

(57) ABSTRACT

The technology described herein is directed towards a computer peripheral device (e.g., keyboard, mouse, USB device or the like) that includes a transceiver for interaction with a wearable device that includes a passive metasurface. The transceiver transmits a wireless radio frequency signal towards the metasurface integrated into the wearable device, whereby the metasurface reflects an altered instance of the incoming signal back to the transceiver. The radiation pattern of the reflected signal can be distinctly altered per metasurface, providing a distinct signature of that particular metasurface that can be detected by the computer peripheral device and/or a computing device coupled to the computer peripheral that is expecting that particular signature. The receipt of an expected, matched signal's signature, can, for example, facilitate proximity detection of the user, authentication of the user and so on, in a seamless way that is efficient and secure.

### RELATED APPLICATIONS

The subject patent application is related to U.S. patent application Ser. No. ______, filed ______, and entitled “PASSIVE WEARABLE DEVICE FOR SECURITY AND AUTHENTICATION” (docket no. 139008.01/DELLP1220US), U.S. patent application Ser. No. ______, filed ______, and entitled “SCALABLE AND COMPACT METASURFACE DESIGN FOR SMART AND FUNCTIONAL WEARABLE DEVICES” (docket no. 139009.01/DELLP1221US), U.S. patent application Ser. No. ______, filed ______, and entitled “INTEGRATED PHYSICAL DEVICE IDENTIFICATION FOR REMOTE MANAGEMENT OF WEARABLE METASURFACES” (docket no. 139010.01/DELLP1222US), U.S. patent application Ser. No. ______, filed ______, and entitled “DIFFERENTIATING PHYSICAL RADIATION PATTERNS IN PASSIVE METASURFACES” (docket no. 139011.01/DELLP1223US), U.S. patent application Ser. No. ______, filed ______, and entitled “CUSTOMIZATION AND APPEARANCE INFORMATION FOR WEARABLE METASURFACES” (docket no. 139012.01/DELLP1224US), U.S. patent application Ser. No. ______, filed ______, and entitled “PROXIMITY BASED MULTIFACTOR AUTHENTICATION USING PASSIVE WEARABLE METASURFACES” (docket no. 139014.01/DELLP1226US), U.S. patent application Ser. No. ______, filed ______, and entitled “AUTOMATIC COMPUTING DEVICE WAKE UP AND LOCK USING PASSIVE WEARABLE METASURFACE” (docket no. 139015.01/DELLP1227US), and U.S. patent application Ser. No. ______, filed ______, and entitled “SOFTWARE STACK AND BACKEND FOR PASSIVE WEARABLE METASURFACES FOR REMOTE MANAGEMENT AND ANALYTICS” (docket no. 139016.01/DELLP1228US), the entireties of which patent applications are hereby incorporated by reference herein.

### BACKGROUND

Existing wearable devices such as rings and wristwatches for activity tracking and/or health monitoring operate by establishing a communication link between the wearable device and a transceiver, generally using BLUETOOTH low energy technology. As such, these devices need electrical components such as a battery, various sensors, circuits, a controller, and antennas within the device, increasing the cost, size, and complexity in design. Moreover, due to the smaller battery size, these wearable devices need to be charged frequently.

### BRIEF DESCRIPTION OF THE DRAWINGS

The technology described herein is illustrated by way of example and not limited in the accompanying figures in which like reference numerals indicate similar elements and in which:

FIG. 1A is a block diagram representation of an example wearable device including a passive metasurface communicating with a computing device via a transceiver embedded in a computer peripheral device, in accordance with various example embodiments and implementations of the subject disclosure.

FIG. 1B is a representation of example computer peripheral devices (keyboard and/or mouse that includes a transceiver for communicating with a metasurface, in accordance with various example embodiments and implementations of the subject disclosure.

FIG. 2 is a representation of an example wearable device above a keyboard with an antenna for an embedded transceiver, in accordance with various example embodiments and implementations of the subject disclosure.

FIG. 3 is a representation of an example wearable device in the form of a ring design, highlighting the passive metasurface communicating with a transceiver embedded in a computer peripheral for coupling to a computing device, in accordance with various example embodiments and implementations of the subject disclosure.

FIG. 4 is a representation of example categories of potential applications of a transceiver embedded in a computer peripheral, in accordance with various example embodiments and implementations of the subject disclosure.

FIG. 5 is a representation of an example surface designed for being implemented at 80 GHz, demonstrating the metasurface's compact and planar features, along with an enlarged portion representation thereof, and an enlarged unit cell representation, in accordance with various example embodiments and implementations of the subject disclosure.

FIG. 6A is a representation of an example wearable device with a passive metasurface in the form of a wrist-wearable (e.g., wristband or bracelet) design, in accordance with various example embodiments and implementations of the subject disclosure.

FIG. 6B is a representation of an example passive portable device with a passive metasurface in the form of a design for affixing to a personal item (e.g., cell phone), in accordance with various example embodiments and implementations of the subject disclosure.

FIG. 7A is a representation of an example wearable device with a passive metasurface in the form of a neck-wearable (e.g., via a lanyard or necklace) design, in accordance with various example embodiments and implementations of the subject disclosure.

FIG. 7B is a representation of an example portable wearable device with a passive metasurface in the form of a design for affixing to a wearable item (e.g., eyeglass frames), in accordance with various example embodiments and implementations of the subject disclosure.

FIG. 8A is a three-dimensional perspective view representation of an example unit cell for a metasurface of a passive wearable device, in accordance with various example embodiments and implementations of the subject disclosure.

FIG. 8B is a representation of an example unit cell designs with geometry variations for different phase profiles, in accordance with various example embodiments and implementations of the subject disclosure.

FIG. 9 is a graphical representation of geometry length versus signal reflection for example passive metasurface device designs, in accordance with various example embodiments and implementations of the subject disclosure.

FIG. 10 is a graphical representation of geometry length versus signal reflection angle data for example passive metasurface device designs, in accordance with various example embodiments and implementations of the subject disclosure.

FIGS. 11A-11C are representations of example metasurfaces with various different design parameters to create distinct per device signatures, in accordance with various example embodiments and implementations of the subject disclosure.

FIG. 12A is a representation of an example wearable device in which a distinct device physical radiation pattern signature is included in a device service tag, in accordance with various example embodiments and implementations of the subject disclosure.

FIG. 12B is a representation of example unit cell designs with different length delay lines (stubs) arrayed for a distinct phase profile, in accordance with various example embodiments and implementations of the subject disclosure.

FIG. 12C is a representation of a map of the example unit cell designs with different length delay lines of FIG. 12A, in accordance with various example embodiments and implementations of the subject disclosure.

FIG. 13 is a graphical representation of different radiation patterns achieved from an example grating lobe-based beam-splitting metasurface, demonstrating the capability for a single reflected beam or a split beam from a wearable device with a passive metasurface, in accordance with various example embodiments and implementations of the subject disclosure.

FIG. 14 is a flow diagram showing example operations related to detecting that received radiation pattern data from a wearable metasurface matches expected radiation pattern data, to establish that a user is within a specific proximity distance of the computing device, in accordance with various example embodiments and implementations of the subject disclosure.

### DETAILED DESCRIPTION

The technology described herein is generally directed towards a smart computer peripheral device that includes a transceiver for interacting with a wearable or otherwise portable metasurface. The computer peripheral device is coupled to a computing device, such as a personal computer or laptop, and can send information regarding the metasurface to the computing device. The transceiver can be embedded into or otherwise coupled to the computer peripheral, such as a monitor, keyboard, or pointing device (e.g., mouse or touchpad).

The transceiver, serving as the system's active component, emits a wireless radio frequency signal towards a metasurface integrated into the wearable/portable device. Upon receiving the signal, the metasurface alters the incoming signal's properties in a predefined manner, and redirects (reflects) the altered instance of the signal back to the transceiver. The receipt of the altered signal at the computing device facilitates detecting the proximity of the user, as well as possibly other actions such as authenticating the user, providing a seamless and intuitive user experience that is both efficient and secure. For example, the peripheral device can wake up or lock the computing device based on the presence or absence of the authenticated user, respectively.

The wearable device embedded with a metasurface or with a metasurface affixed thereto, can become a component in a user's daily attire, for example. Significantly, the wearable device and metasurface can be passive, requiring no internal or external power source to operate as a reflecting device.

By employing very high (e.g., millimeter wave (mmWave) to terahertz (THz)) frequencies, the system ensures that the device is activated only within a specific proximity distance (e.g., on the order of a few feet), enhancing user experience by preventing unintended interactions. One implementation is thus based on using mm Wave to sub-THz frequencies (short range communication) for this operation, which allows for an adequate yet relatively close distance between the user and the transceiver for activation. Furthermore, the metasurface pattern size scales with frequency, resulting in smaller patterns at higher frequencies and larger patterns at lower frequencies. To incorporate the metasurface pattern into a wearable ring, for example, a smaller pattern size is needed relative to a metasurface in a wearable wristband, thus benefitting from operation at higher frequencies, such as sub-THz.

The ability to scale the metasurface pattern with frequency allows for customizable interactions depending on a desired application. Such flexibility potentially can be extended to different forms of communication and control within digital environments, facilitating new types of user-device interfaces.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in RF communications and RF devices in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

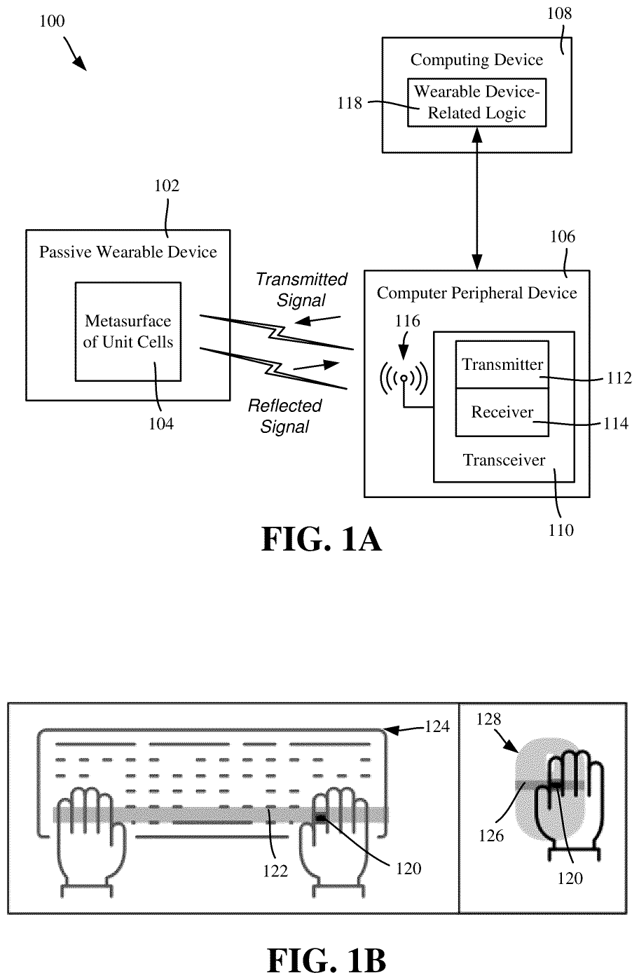

FIG. 1A is a block diagram representation of one example implementation of a system 100 in which a wearable device 102, which includes a metasurface of unit cells 104, communicates with a computer peripheral (device) 106 coupled to a computing device 108. In the example of FIG. 1A, the computer peripheral device 106 includes an embedded, integrated or otherwise internal transceiver 110, which in turn includes a transmitter 112 and receiver 114. The transceiver components are coupled to an antenna 116 that transmits signals to the metasurface 104 of the passive wearable device 102, which as described herein, alters a redirected instance of the signal's characteristics reflected to the transceiver's receiver 114. Based on the received signal, wearable device-related logic 118 (e.g., a hardware or software program running in the computing device 108) can analyze the reflected signal and take some action based thereon as described herein, such as to wake the operating system program or the like for execution in the computing device. It is also feasible for the computer peripheral device 106 to include the wearable device-related logic 118, or the wearable device-related logic 118 can be divided between the computer peripheral device 106 and the computing device 108.

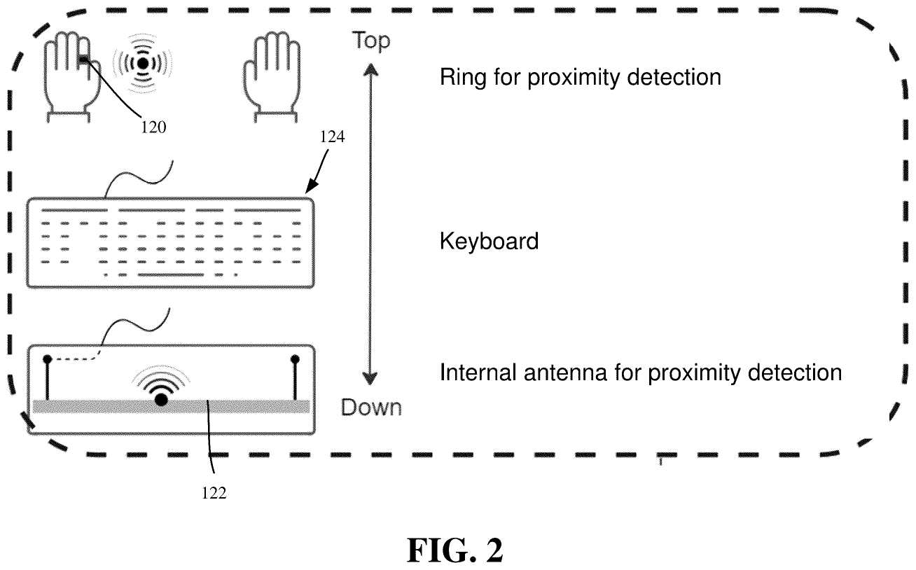

FIGS. 1B and 2 show the general concept of a wearable ring 120 with a metasurface interacting with a peripheral device 124 or 128. The ring-based wearable metasurface 120 can act as a key to lock and unlock a computer, for example, or at least detect the user's presence to wake the computer, such as to automatically open present an interactive lock screen when proximity is detected.

More particularly, FIG. 1B shows the concept of an example ring 120 with a metasurface that couples to a transceiver/antenna 122 incorporated into a keyboard 124. Alternatively, or in addition to the transceiver/antenna 122 incorporated into the keyboard 124, a transceiver/antenna 126 can be incorporated into a mouse 128 or other pointing device.

FIG. 2 shows a top-downwards description of the ring 120 on a user's hand above the keyboard 124 as is typically the position when typing thereon. In this hand position, the transceiver/antenna 122 is at an acceptable angle for sending signals to and receiving reflected signals from the ring 120. The mouse (not shown in FIG. 2) can similarly have its antenna oriented to couple with the ring/metasurface above the mouse as is typical during mouse interactions. Note that with a laptop computer, the antenna can be in a similar position with respect to the laptop's integrated keyboard and touchpad or the like. When interacting with the keyboard/mouse pad, the user's ring is naturally oriented in a direction generally towards the antenna at a good angle for coupling.

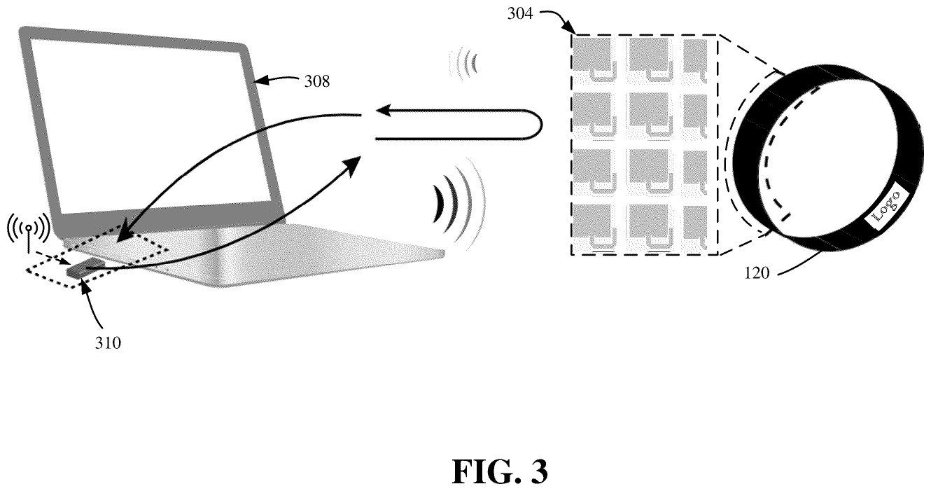

The transceiver can also be integrated into a separate peripheral device for coupling to a computer port. For example, as shown in FIG. 3, an external transceiver 310 can be designed as a universal serial bus (USB) device or other suitable device that plugs into a port of a computing device 308. In the example of FIG. 3, a portion of the metasurface unit cells 304 is shown enlarged and interacting with the transceiver 310 (via antenna 214) when inserted into the port of the computer 308 and powered up. In general, the user only needs to orient his or her hand at a reasonably close and suitable reflecting angle for the system to operate.

To summarize, described is transceiver technology incorporated directly into (embedded within) smart peripheral devices for proximity detection. Non-limiting example peripheral devices include a keyboard, mouse, monitor, webcam or speakerphones, any of which can enable proximity detection. By integrating transceiver technology into peripheral devices rather than the computing device itself, the capability for proximity detection can extend to a broader range of applications and potential users.

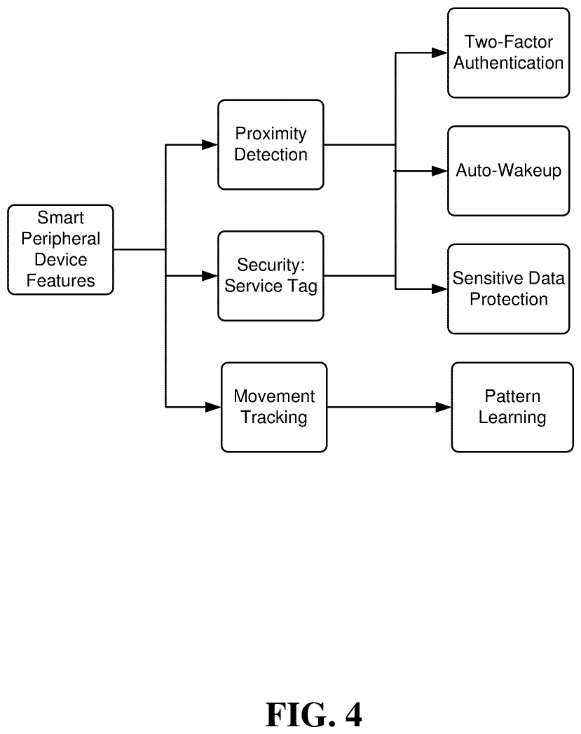

FIG. 4 shows some potential applications of a transceiver embedded within a smart peripheral device. As can be seen, based on proximity detection, which can be in conjunction with security detection (via a service tag as described herein) can be used for two-factor authentication, automatic wakeup of a coupled computing device (or automatic unlock/lock), and sensitive data protection. Movement tracking is also possible, e.g., for pattern learning to better interact with a particular user based on that user's prior movements.

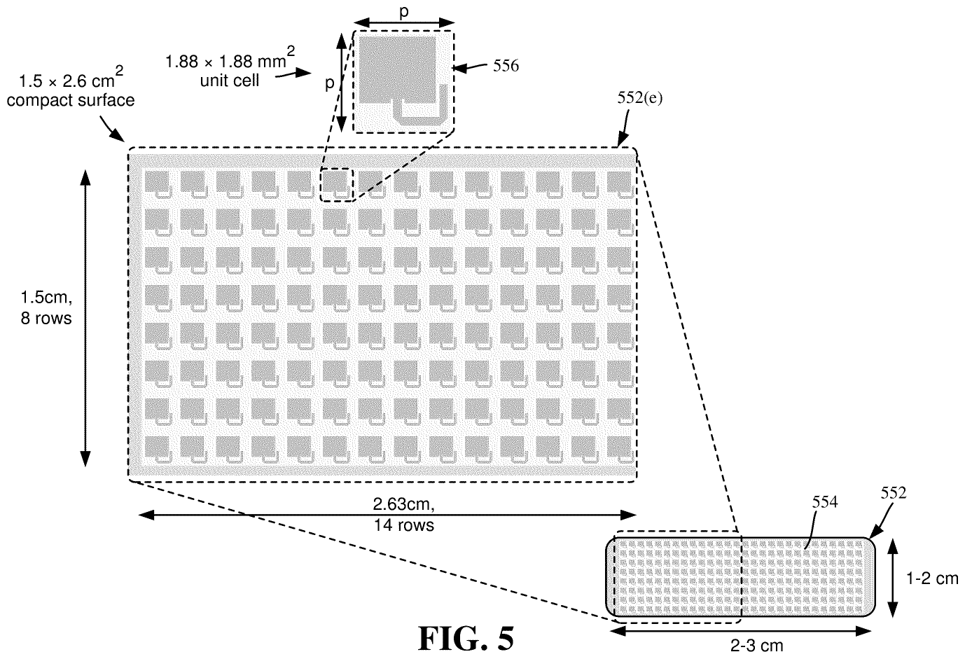

FIG. 5 shows an example wearable device 552 that incorporates a metasurface 554 with an 8×28 array of unit cells. An enlarged portion 552 (e) highlighting an 8×14 unit cell array of the metasurface 554 is shown, and one of the unit cells 556 is enlarged.

In one example implementation, the metasurface is fabricated on flexible material (substrate and metallic ground plane) to facilitate forming the wearable device into a ring shape (FIG. 3) suitable for wearing on a human finger. The dimensions shown in FIG. 5 are based on a typical adult finger size and a frequency of 80 gigahertz (GHz). The fabrication tolerance of the metasurface design described herein makes this design easily scalable up to sub-terahertz frequencies, which is suitable for miniaturization to fit on a ring. As shown in FIG. 5, each unit cell in this example measures 1.88 mm×1.88 mm. These unit cells can be arranged in a matrix to fit within a ring that measures 1.5 cm in width and 2 to 3 cm in length when flattened. Additionally, the design is conformal, allowing for adjustments to accommodate bending of the surface, ensuring both flexibility and functionality in wearable applications.

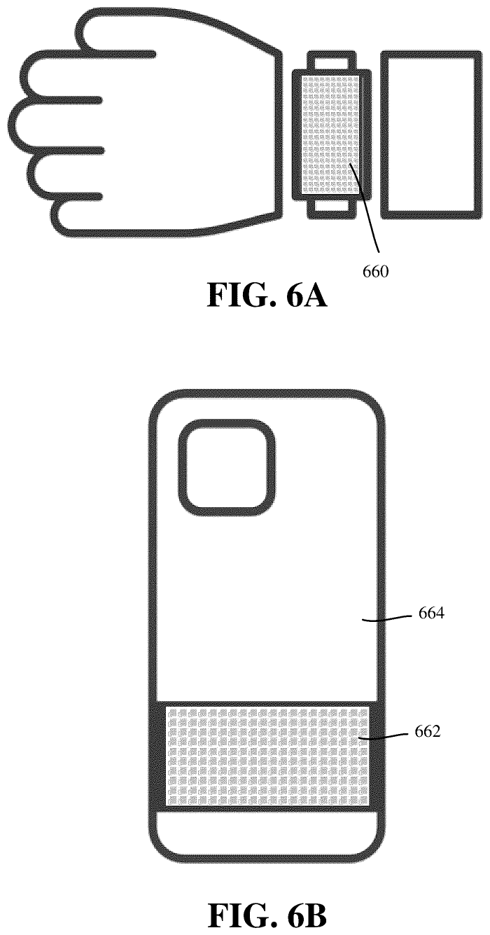

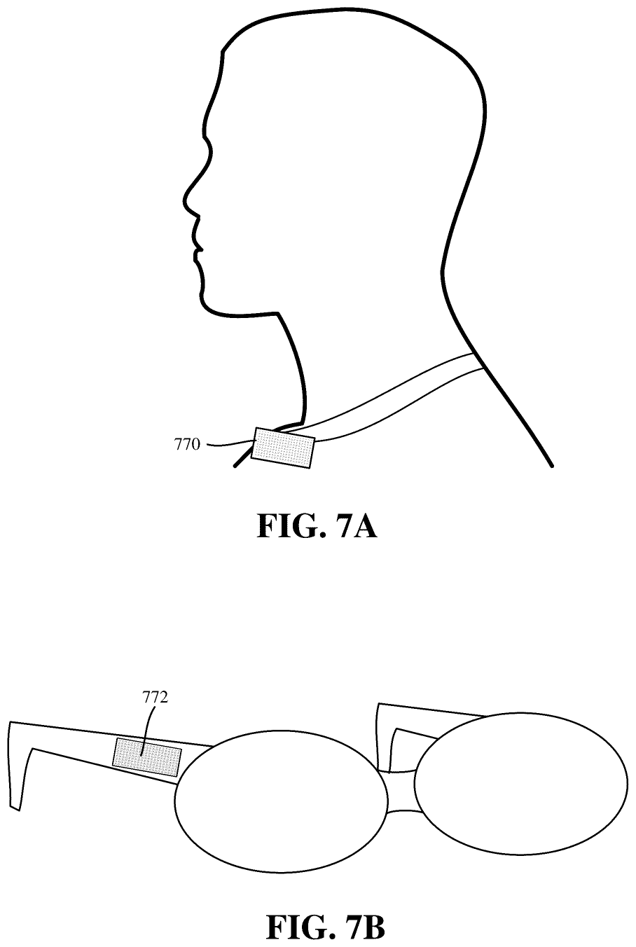

FIGS. 6A and 6B show alternative, non-limiting examples of wearable devices, namely a wrist-worn (e.g., wristband or bracelet) device 660, and a portable device 662 attached to a cell phone case 664. Although the portable device 662 attached to the cell phone case 664 is not “wearable” in the conventional sense, it can be considered “wearable” to the extent it accompanies a user and is typically part of the user's personal accoutrements that are generally within the user's possession, and indeed, can be “worn” in a user's pocket. FIGS. 7A and 7B show metasurfaces worn around a user's neck (e.g., as a necklace, locket or in lanyard) wearable device 770, and a wearable device 772 affixed to a user's eyeglass frame, respectively. Other non-limiting examples that are not explicitly shown include an identification badge, a name tag patch (e.g., affixed at a conference), a headset or headphones (e.g., regularly worn while working with a computer), and so on. Note that while the metasurface itself is passive, the metasurface can be coupled to a non-passive device, e.g., a watchband of a user's existing battery-powered wristwatch. Some example consideration factors when choosing among the wearable metasurface devices are summarized in the following table:

| User Needs | Product |
|---|---|
| Tranceiver Alignment | Ring |
| Gain | Wrist-worn Device |
| Convenience | Affixed / Embedded to Phone Case |

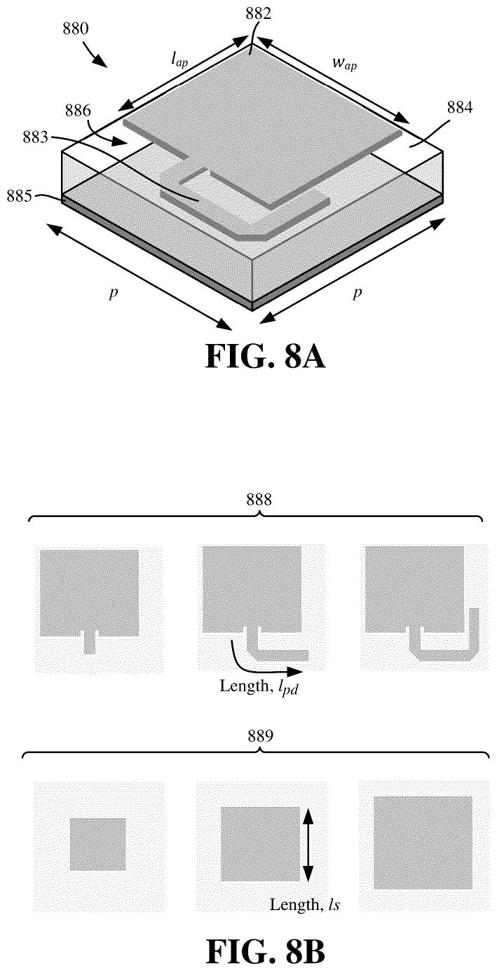

FIG. 8A shows a three-dimensional perspective view of one metasurface design 880 that includes a metallic patch element 882 and a metallic phase delay element 883. The metallic patch element 882 and the metallic phase delay element 883 are fabricated atop a substrate 884; a ground plane layer (panel) 885 beneath the substrate 884 in conjunction with the metallic patch element 882 provides an aperture 886 of length lₐₚ and width wₐₚ that facilitates passive operation of the unit cell 880. As is understood, an entire array of unit cells can be fabricated on a single substrate/ground plane.

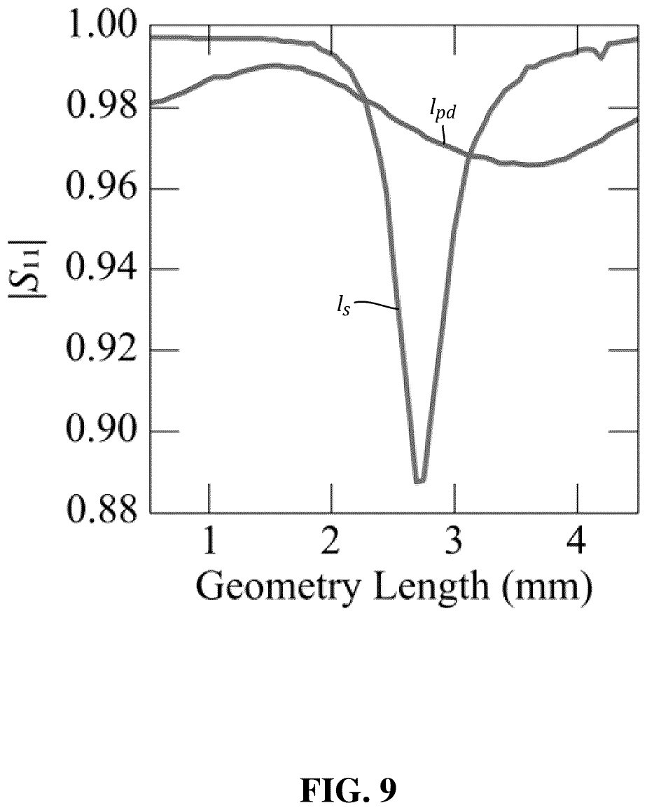

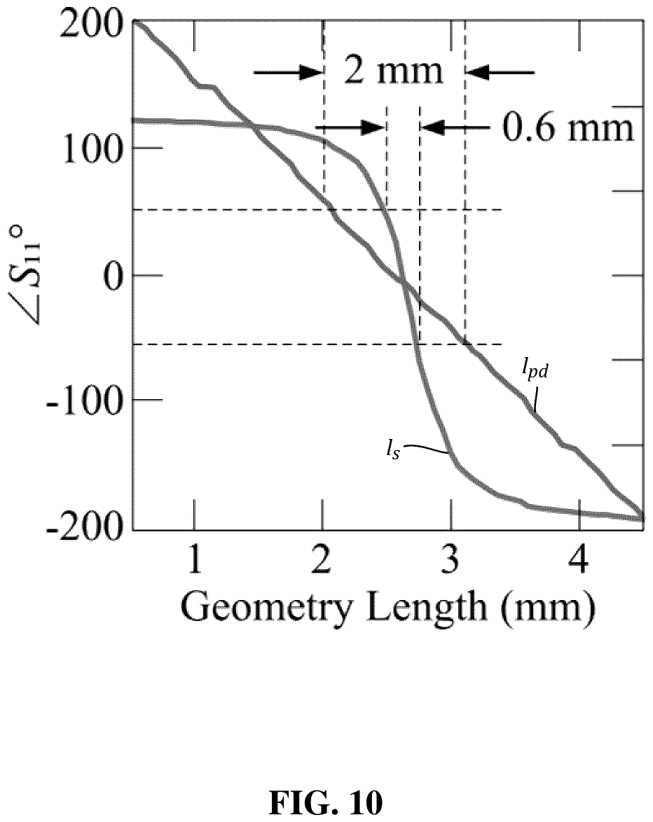

The length of the phase delay element 883 (i.e., metallic stub) adjusts the phase of the reflected signal. Such a phase delay element-based designs (888, FIG. 8B) overcome several challenges that regular variable-patch size approaches (889, FIG. 8B) encounter, as demonstrated by the simulation results shown in FIGS. 9 and 10. The simulation shows a full-wave numerical experiment result for an example unit-cell design using line-delay elements, which demonstrates phase delay element-based phase linearity compared to conventional size variation. The design was originally designed for 30 GHz, with lₐₚ=2.93 mm, wₐₚ=3.31 mm, and p=5.01 mm.

More particularly, FIGS. 9 and 10 highlight how the patch size variation approach designs 889 (without delay lines) suffer from phase errors, due to a combined effect of fabrication tolerance and the rapid phase variation near resonance. As shown in FIG. 10, the phase undergoes a 100 degree change within a mere 0.6 mm range. With typical fabrication tolerances between 0.07 to 0.20 mm (3-8 mil), this design is prone to phase errors, particularly at higher frequencies and/or when using cost-effective, lower precision manufacturing techniques. In contrast, the phase delay element designs 888 (FIG. 8B) with delay lines exhibit a flatter amplitude profile and a linear phase trend, as also shown in FIGS. 9 and 10, respectively. The phase shift with the phase delay element design approach 888 is proportional to twice the line length, offering significantly more reliable and consistent performance.

The phase delay element implementation design is appropriate for high frequency operation in that the design reduces the physical size and minimizes interference. More particularly, a metasurface design uses the phase delay element for tuning reflected signals' phase for high frequency operation, which enhances device compactness, aesthetic integration, and reduces interference by avoiding crowded spectral bands. At the same time, the design facilitates straightforward fabrication with the metallic patch element and phase delay element with a conformal design for versatile integration. Designing the length of the phase delay element for tuning not only cases the manufacturing process, but also significantly enhances the fabrication tolerances, which can significantly reduce barriers to innovation and deployment. The metasurface design's conformal nature is beneficial in wearable technology.

A wearable device can have information encoded into its reflected signal based on how the reflected signal is altered by the metasurface relative to the transmitted signal. More particularly, any device can be crafted with a distinct metasurface pattern that distinguishes that metasurface from others. The distinct identifiability of each device is based on its physical radiation characteristics, in that each metasurface can generate a distinct radiation pattern in the reflected signal, which differentiates each such metasurface while ensuring that each metasurface can uniquely interact with the corresponding system.

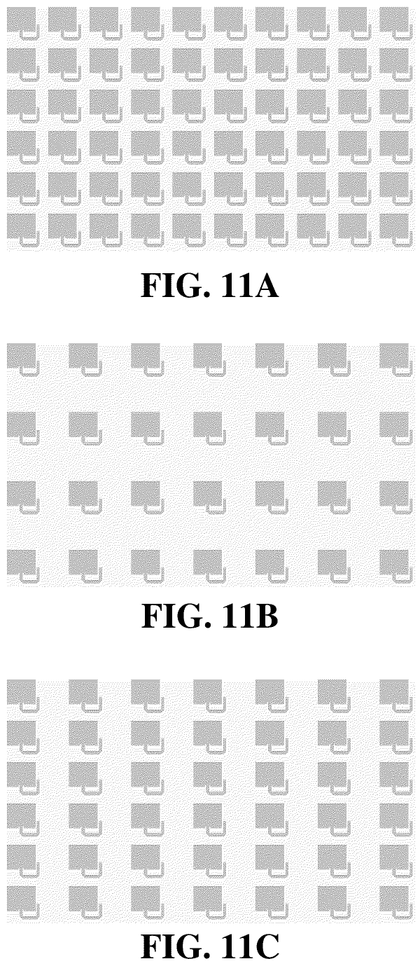

To this end, each device can be manufactured with a system-unique set of metasurface scatters (or simply unit-cells) to provide variations in terms of phase, gain, beam patterns, dual beam splitting, directivity, and the like which can be achieved by altering the unit-cell shape, phase, size, spacing, rotation, among other characteristics, as shown in FIGS. 11A-11C; the characteristics can be unique and randomized/or altered according to a controlled pseudorandom pattern. For example, the example metasurface of FIG. 11A can be considered a standard metasurface, while the more spaced-apart unit cells of FIG. 11B (relative to FIG. 11A) can provide a variation on the beam width. The horizontal spacing and vertical spacing differences in FIG. 11C can result in asymmetric beam splitting based on grating lobes (resulting in variations on the number of reflected beams and their angles).

An advantageous characteristic of the wearable technology described herein is the scalable design of the metasurface, which can be adapted to fit various sizes and types of wearables. The flexibility to customize the size of the metasurface based on the surface area of the wearable item enables a tailored approach to meet specific user needs. Further, as described with refence to FIGS. 11A-11C, there can be a distinct per-device performance signature, possibly globally unique, by which each device is manufactured with a different set of metasurface scatters (i.e., unit-cells) to provide variations in terms of phase, gain, beam patterns, multiple (e.g., dual) beam splitting, directivity and the like, which can be achieved by altering the unit-cell shape, phase, size, spacing, rotation and so forth.

This distinct performance signature can be linked to a system-unique device ID, in which the system expects to detect the predetermined performance signature when the wearable device is linked to the user's computing device and/or associated account. For example, the wearable device-related logic 116 (FIG. 1A) or 117 (FIG. 1B) can look for an expected radiation pattern and match it to a user account; if not matched, or no signal is reflected, metasurface-based access is denied, although another way to access the account may be enabled, such as if the user has forgotten to wear the device. There also can be shared access to a computing device, and thus the logic can map one radiation pattern signature to one authorized user of that computing device and to that user's profile/account, and map a different radiation pattern signature to another authorized user of that computing device and to that other user's profile/account.

Among the benefits of distinct metasurfaces and their corresponding distinct physical radiation patterns is with respect to integrated physics device identification for remote management of wearable metasurfaces. A concern regarding the security of a system as described herein is to ensure that only a specific, authorized wearable device can unlock the system/account, rather than just any wearable device. To address this, each device can be crafted with a different metasurface pattern that distinguishes it from others.

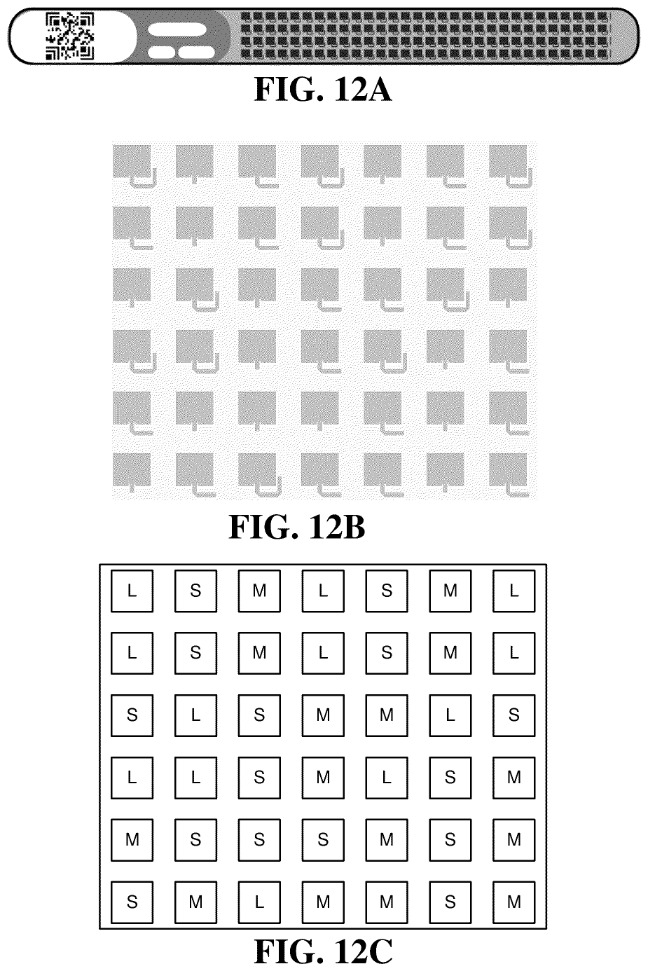

The distinct identifiability via customized radiation characteristics also facilitates the association of a service tag encoding for individual metasurface identification. By way of example, consider that the customized radiation characteristics can encode/correspond to a number of (e.g., seven) alphanumeric characters, that encode the specific differences in each metasurface's design, such as appearance, materials, location, antenna patterns, beam splitting nature, range, and so forth. Individual performance parameters can be encoded as well. An example metasurface with an associated service tag that is also encoded in the customized radiation characteristics is shown in FIG. 12A.

This customization involves distinct radiation patterns generated by each metasurface, tailored specifically to each device ID. This device ID can be incorporated or encrypted within an enterprise's service tag mechanism. For example, because peripherals do not need a separate service tag, a device ID in case of a wearable device is desirable to distinguish the physical features, internal metasurface design patterns, beam patterns, materials, location, and in general for remote management, including activation of the device when purchasing or deactivation in case if the device gets lost.

With respect to improved security and privacy, leveraging the distinct signal manipulation capabilities of metasurfaces, the technology described herein offers an advanced level of security. The complexity and customization potential of the reflected signals make it extremely challenging for unauthorized entities to mimic or hack. Indeed, the different characteristics of each ring or wearable device, achieved through specific customization of the radiation characteristics, can include the beam width (angular scan range) and the asymmetric beam splitting, which varies according to the number of beams and their specific angles. This ensures that each ring interacts individually with the system, providing a secure and personalized method of access.

As a further example, in addition to the spacing differences described with reference to FIGS. 11A-11C, consider the different patterns of unit cell delay line (stub) lengths shown in FIG. 12B. FIG. 12C shows a map of the lengths, e.g., S (short), M (medium) and L (long) which can be distinctly arranged per metasurface. The pattern of the length arrangements of FIG. 12B, which results in one particular phase profile, can be varied for another device, and so on, providing another variable characteristic that modifies the physical radiation pattern of the reflected signal relative to the transmitted signal. Note that while three different delay line lengths are depicted, there can be more than three different lengths, providing even more variations in phase profiles among metasurfaces.

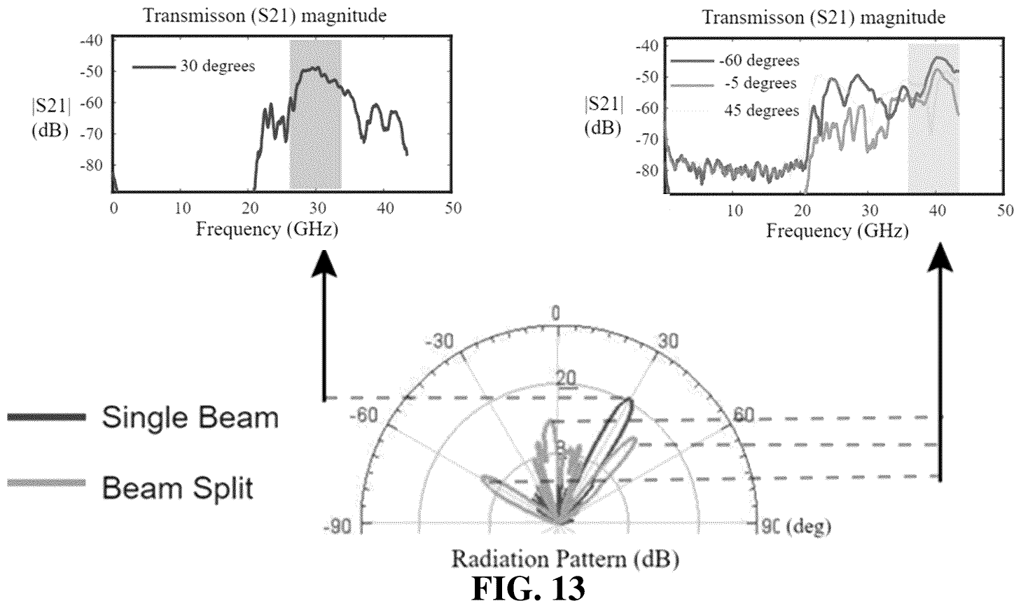

FIG. 13 shows a different radiation pattern achieved from a metasurface configured for beam splitting. The frequency is tunable based on the metasurface unit cell size.

One or more example embodiments can be embodied in a system, such as described and represented herein. The system can include a computer peripheral device, and a wireless radio frequency receiver coupled to the computer peripheral device. The system can further include a wearable metasurface that can include respective unit cells that redirect transmitted wireless radio frequency signals, transmitted by a wireless radio frequency transmitter and impinging on at least part of the metasurface, as reflected wireless radio frequency signals for reception by the wireless radio frequency transceiver. The respective passive unit cells can include respective elements that alter at least one property of the reflected wireless radio frequency signals relative to the transmitted wireless radio frequency signals to facilitate proximity detection, by a computing device, of a user wearing the wearable metasurface.

The computing device can be coupled to the computer peripheral device; the computer peripheral device can operate to wake the computing device upon proximity detection of the user via the wearable metasurface. The respective passive unit cells alter at least one property of the reflected wireless radio frequency signals to produce a distinct signature of the wearable metasurface as part of the reflected wireless radio frequency signals. The distinct signature can distinctly identify the wearable metasurface to facilitate authentication of the user to the computing device.

The wireless radio frequency transmitter and the wireless radio frequency receiver can include a wireless radio frequency transceiver. The wireless radio frequency transceiver can be embedded into the computer peripheral device. The system further can include a computing device, and the computer peripheral device can be coupled to an external port of the computing device.

The computer peripheral device can include a keyboard, a pointing device, or a combination of a keyboard and a pointing device.

The computer peripheral device can include a camera device, a microphone device, or a combination of a camera device and a microphone device.

The computer peripheral device can include an audio output device, a display device, or a combination of an audio output device and a display device.

One or more example embodiments can be embodied in a system, such as described and represented herein. The system can include a transceiver that can include a receiver, and a transmitter that transmits a transmitted wireless radio frequency signal. A computer peripheral device can be coupled to the transceiver, and a metasurface can include unit cells that receive the transmitted radio frequency signal and redirect a reflected instance of the transmitted radio frequency signal to the receiver; the unit cells can alter characteristics of the reflected instance of the radio frequency signal, relative to the transmitted radio frequency signal, to generate a signature associated with the metasurface.

The computer peripheral device can include a universal serial bus (USB) device configured for coupling to a USB port of a computing device.

The transceiver can be incorporated into the computer peripheral device.

The computer peripheral device can include at least one of: a keyboard, a pointing device, a camera device, a microphone device, an audio output device, or a display device.

The metasurface can be configured to be a wearable device worn by a user, and the signature associated with the metasurface can facilitate proximity detection of the user to the computer peripheral device when the reflected instance of the radio frequency signal can be received at the receiver.

The metasurface can be configured to be a wearable device worn by a user, the computer peripheral device can be coupled to a computing device, and the signature associated with the metasurface can be a distinct signature that facilitates authentication of the user on the computing device when the reflected instance of the radio frequency signal can be received at the receiver.

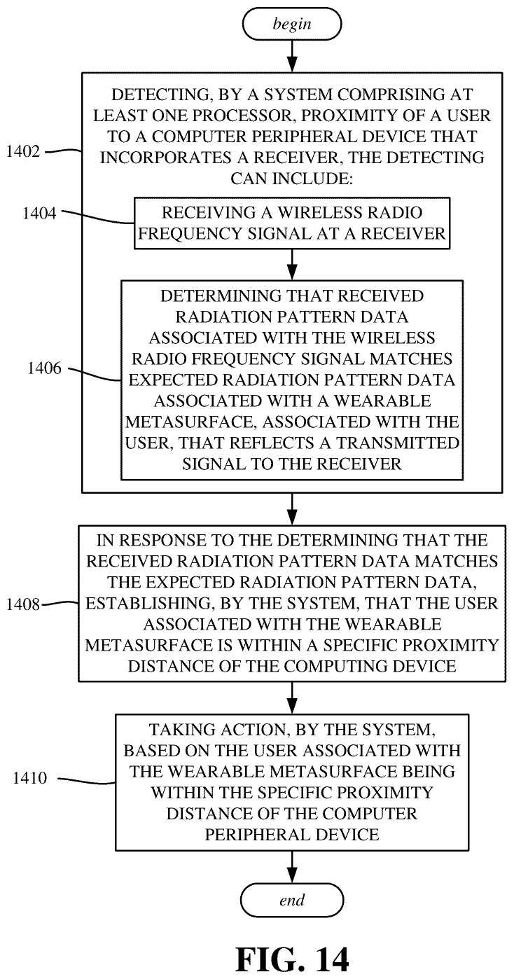

One or more example aspects, such as corresponding to example operations of a method, or a system/a machine-readable medium having executable instructions that, when executed by a processor, facilitate performance of the operations, are represented in FIG. 14. Example operation 1402 represents detecting, by a system comprising at least one processor, proximity of a user to a computer peripheral device that incorporates a receiver. The detecting can include receiving a wireless radio frequency signal at a receiver (example operation 1404), and determining that received radiation pattern data associated with the wireless radio frequency signal matches expected radiation pattern data associated with a wearable metasurface, associated with the user, that reflects a transmitted signal to the receiver (example operation 1406). Example operation 1408 represents, in response to the determining that the received radiation pattern data matches the expected radiation pattern data, establishing, by the system, that the user associated with the wearable metasurface is within a specific proximity distance of the computing device. Example operation 1410 represents taking action, by the system, based on the user associated with the wearable metasurface being within the specific proximity distance of the computer peripheral device.

Taking the action can include activating a program on a computing device coupled to the computer peripheral device.

Taking the action can include authenticating the user to access a computing device coupled to the computer peripheral device.

The action can include a first action, and further operations can include detecting, by the system, that the user is no longer within the specific proximity distance of the computer peripheral device, and, in response to the detecting that the user is no longer within the specific proximity distance of the computer peripheral device, taking a second action.

As can be seen, the technology described herein is directed to a computer peripheral device with an integrated transceiver that interacts with a wearable/portable device's metasurface, such as for proximity detection and/or seamless authentication on digital computing devices such as a laptop/desktop PC. This is implemented through a passive metasurface, to enhance personal security and facilitate seamless interaction with digital environments. Metasurfaces, being engineered interfaces, manipulate electromagnetic waves in ways that traditional materials cannot, without requiring any power source, making them very suitable for passive operations in wearable technology, as well as facilitating distinct radiation patterns per metasurface.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a computer peripheral device;
a wireless radio frequency receiver coupled to the computer peripheral device; and
a wearable metasurface comprising respective unit cells that redirect transmitted wireless radio frequency signals, transmitted by a wireless radio frequency transmitter and impinging on at least part of the metasurface, as reflected wireless radio frequency signals for reception by the wireless radio frequency transceiver,
wherein the respective passive unit cells comprise respective elements that alter at least one property of the reflected wireless radio frequency signals relative to the transmitted wireless radio frequency signals to facilitate proximity detection, by a computing device, of a user wearing the wearable metasurface.

2. The system of claim 1, wherein the computing device is coupled to the computer peripheral device, and wherein the computer peripheral device operates to wake the computing device upon proximity detection of the user via the wearable metasurface.

3. The system of claim 2, wherein the respective passive unit cells alter the at least one property of the reflected wireless radio frequency signals to produce a distinct signature of the wearable metasurface as part of the reflected wireless radio frequency signals.

4. The system of claim 3, wherein the distinct signature distinctly identifies the wearable metasurface to facilitate authentication of the user to the computing device.

5. The system of claim 1, wherein the wireless radio frequency transmitter and the wireless radio frequency receiver comprise a wireless radio frequency transceiver.

6. The system of claim 5, wherein the wireless radio frequency transceiver is embedded into the computer peripheral device.

7. The system of claim 5, further comprising a computing device, wherein the computer peripheral device is coupled to an external port of the computing device.

8. The system of claim 1, wherein the computer peripheral device comprises a keyboard, a pointing device, or a combination of a keyboard and a pointing device.

9. The system of claim 1, wherein the computer peripheral device comprises a camera device, a microphone device, or a combination of a camera device and a microphone device.

10. The system of claim 1, wherein the computer peripheral device comprises an audio output device, a display device, or a combination of an audio output device and a display device.

11. A system, comprising:
a transceiver comprising a receiver, and a transmitter that transmits a transmitted wireless radio frequency signal;
a computer peripheral device coupled to the transceiver; and
a metasurface comprising unit cells that receive the transmitted radio frequency signal and redirect a reflected instance of the transmitted radio frequency signal to the receiver, wherein the unit cells alter characteristics of the reflected instance of the radio frequency signal, relative to the transmitted radio frequency signal, to generate a signature associated with the metasurface.

12. The system of claim 11, wherein the computer peripheral device comprises a universal serial bus (USB) device configured for coupling to a USB port of a computing device.

13. The system of claim 11, wherein the transceiver is incorporated into the computer peripheral device.

14. The system of claim 13, wherein the computer peripheral device comprises at least one of: a keyboard, a pointing device, a camera device, a microphone device, an audio output device, or a display device.

15. The system of claim 13, wherein the metasurface is configured to be a wearable device worn by a user, and wherein the signature associated with the metasurface facilitates proximity detection of the user to the computer peripheral device when the reflected instance of the radio frequency signal is received at the receiver.

16. The system of claim 11, wherein the metasurface is configured to be a wearable device worn by a user, wherein the computer peripheral device is coupled to a computing device, and wherein the signature associated with the metasurface is a distinct signature that facilitates authentication of the user on the computing device when the reflected instance of the radio frequency signal is received at the receiver.

17. A method, comprising:
detecting, by a system comprising at least one processor, proximity of a user to a computer peripheral device that incorporates a receiver, the detecting comprising:
receiving a wireless radio frequency signal at a receiver, and
determining that received radiation pattern data associated with the wireless radio frequency signal matches expected radiation pattern data associated with a wearable metasurface, associated with the user, that reflects a transmitted signal to the receiver;
in response to the determining that the received radiation pattern data matches the expected radiation pattern data, establishing, by the system, that the user associated with the wearable metasurface is within a specific proximity distance of the computing device; and
taking action, by the system, based on the user associated with the wearable metasurface being within the specific proximity distance of the computer peripheral device.

18. The method of claim 17, wherein the taking of the action comprises activating a program on a computing device coupled to the computer peripheral device.

19. The method of claim 17, wherein the taking of the action comprises authenticating the user to access a computing device coupled to the computer peripheral device.

20. The method of claim 17, wherein the action is a first action, and further comprising detecting, by the system, that the user is no longer within the specific proximity distance of the computer peripheral device, and, in response to the detecting that the user is no longer within the specific proximity distance of the computer peripheral device, taking a second action.
